(19) United States
(12) Patent Application Publication
(10) Pub. No.: US 2010/0236122 A1
(43) Pub. Date: Sep. 23, 2010

(54) Flowforming Gun Barrels and Similar Tubular Devices

(76) Inventor: Matthew V. Fonte, Charlestown, MA (US)

Correspondence Address: Sunstein Kann Murphy & Timbers LLP, 125 SUMMER STREET, BOSTON, MA, 02110-1618, US

(21) Appl. No.: 11/460,100

(22) Filed: Jul. 26, 2006

(51) Int. Cl. B23P 15/00

(52) U.S. Cl. 42/76.1

(57) ABSTRACT

Gun barrels and similar tubular devices for repeatedly guiding fired projectiles are fabricated from superalloys, titanium metals, tantalum metals, and similar metal materials by a flowforming process. Combinations of these metals are also flowformed to produce gun barrels and projectile-guiding tubes. In addition, inner liners for such barrels and tubes are made with these metals and flowforming processes. These barrels and tubular devices can withstand high temperatures and corrosive environments. The flowforming process is efficient and produces strong, yet thin and/or light weight, gun barrels and similar tubular devices.

### RELATED APPLICATIONS

(None)

### BACKGROUND OF THE INVENTION

Gun barrels and tubular devices for sending projectiles to desired targets have been in existence for centuries. These barrels and tubular devices were devised by man for a variety of reasons. The existence of explosive propellants and subsequent refinements in their compositions and knowledge of the properties of these propellants have allowed a wide range of tubular devices and gun barrels to be fabricated for use in sending projectiles toward specific targets. The velocity of projectile movement as well as projectile accuracy was increased when such tubular devices and barrels were devised. The existence of these barrels and tubular devices changed, and is still changing, the conduct of warfare. They altered the way mankind procured animal food supplies. They have been used in sport as well as in more nefarious activities of mankind. They are used to protect man and his property by the military, by police, as well as by individuals. They are used for a variety of purposes when accurate projectile movement is sought, such as penetration of hard objects, applying soft projectiles to surfaces, sending materials to distant locations, etc.

The material that was historically used to make gun barrels and tubular devices for sending projectiles to desired targets was metal. Today, metal is still the predominant material used to manufacture these barrels and devices. Metal has the desired properties of strength to withstand the pressures that are generated when the explosive propellants expand within the barrel or tube as the projectile is accelerated toward the target, and of maintenance of desired shape as the barrels and devices are used repetitively to send multiple projectiles to their targets.

Typically, the metal used to manufacture gun barrels and tubular devices for sending projectiles to desired targets is made of iron or an iron alloy such as steel. This metal is strong but is heavy and subject to corrosion. It is also subject to metal fatigue at higher temperatures, which are generated with higher firing rates and modern explosive propellants. During the manufacturing process, the metal is usually cast, forged, pressed, rolled, extruded, rotary forged, or swaged (GFM swaged) into the desired shape for the sought barrel or tubular device. A subsequent machining step is generally employed to refine the shape of the barrel or device.

In spite of the long history of the existence of gun barrels and tubular devices for sending projectiles to desired targets, there is a need for gun barrels and related tubular devices which are made of metals that are light weight. There is a need for gun barrels and related tubular devices that can withstand elevated temperatures. It is also apparent that there is a need to make gun barrels and related tubular devices that do not corrode, can withstand the erosive effects of the chemicals generated during the projectile firing process, and maintain their strength and shape during constant use. In addition, there is need for improved manufacturing methods for gun barrels and similar tubular devices so the fabrication steps are few and metal waste is minimized. There is a need for more efficient and economical methods and materials for manufacturing gun barrels and similar tubular devices.

### SUMMARY OF THE INVENTION

This invention is directed to methods of making tubes for repeatedly guiding fired projectiles such as barrels for rifles, shotguns, naval guns, or handguns; tubes for mortars, howitzers, or similar weapons; and tubular launchers for rockets, grenades, or similar weapons. These barrels and tubular devices all have the property and purpose of directing fired projectiles including bullets, shot, rounds, rockets, shells, and the like toward specific targets. In addition to their guidance purpose, these barrels and tubular devices serve as enclosed chambers that allow the projectiles to accelerate to a high speed before the projectiles exit the barrels or tubular devices. This acceleration is accomplished by the rapid expansion of ignited or initiated explosive propellants that reside behind the projectiles as the propellants and projectiles sit in the proximal region of the barrels or tubular devices. The expansions of the ignited or initiated explosive propellants push and accelerate the projectiles as they traverse the length of the barrel or tubular devices during the firing process.

The methods of this invention comprise flowforming metals that have not heretofore been used to fabricate gun barrels or tubular devices for repeatedly guiding fired projectiles. The metals include nickel-based superalloys, cobalt-based superalloys, iron-based superalloys, high strength steel, titanium and titanium alloys, tantalum and tantalum alloys, chromium and chromium alloys, zirconium and zirconium alloys, niobium and niobium alloys, and two or more of these metals that have been integrally bonded together. These metals are initially fabricated as preforms that are suitable for flowforming into the desired gun barrel or designated tubular device.

With the methods of this invention, the metals can also be flowformed into thin tubes which can be used as inner liners of gun barrels or tubular devices for repeatedly guiding fired projectiles.

This invention is also directed to methods of making tubes for repeatedly guiding fired projectiles when the metals are flowformed from preforms that are made of two or more metals that have been integrally bonded together, where one of the metals is a nickel-based superalloy, a cobalt-based superalloy, an iron-based superalloy, a high strength steel, titanium or a titanium alloy, tantalum or a tantalum alloy, chromium or a chromium alloy, zirconium or a zirconium alloy, or niobium or a niobium alloy, and at least one metal that is not from this aforesaid group. In these methods, the at least one other metal can be a steel that has heretofore conventionally been used to form gun barrels or similar tubular devices.

In addition, this invention is directed to tubes for repeatedly guiding fired projectiles such as barrels for rifles, shotguns, naval guns, or handguns; tubes for mortars, howitzers, or similar weapons; and tubular launchers for rockets, grenades, or similar weapons. These barrels and tubular devices comprise metals such as nickel-based superalloys, cobalt-based superalloys, iron-based superalloys, high strength steel, titanium or titanium alloys, tantalum or tantalum alloys, chromium or chromium alloys, zirconium or zirconium alloys, niobium or niobium alloys, or two or more of these metals that have been integrally bonded together, which have been flowformed into the appropriate tubular shape. Prior to this invention, these metals have not been fabricated into gun barrels or tubular devices for repeatedly guiding fired projectiles.

The tubes of this invention for repeatedly guiding fired projectiles also include two or more metals that have been integrally bonded together into a preform where one of the metals is a nickel-based superalloy, a cobalt-based superalloy, an iron-based superalloy, a high strength steel, titanium or a titanium alloy, tantalum or a tantalum alloy, chromium or a chromium alloy, zirconium or a zirconium alloy, niobium or a niobium alloy, and at least one other metal that is not from this aforesaid group. In these instances, the at least one other metal can be a steel that has heretofore conventionally been used to form gun barrels or similar tubular devices. These fabricated preforms are flowformed in this invention into gun barrels or similar tubular devices.

These flowformed gun barrels and tubular devices can withstand high temperatures that are generated with rapid firing regimens which are often sought for weapons that use tubes for repeatedly guiding fired projectiles. These gun barrels and tubular devices can withstand the corrosive effects of the chemical reactions of the projectile propellants during the firing process, as well as the normal oxidation that often takes place when conventional gun barrels and similar tubular devices are dormant. These gun barrels and tubular devices can also withstand the erosive effects of the projectiles and burning propellants as the projectiles are fired. In addition, the metals of this invention can be efficiently fabricated by the flowforming process into thin wall gun barrels and similar tubular devices that are strong and light weight. In fact, the flowformed tubular devices of this invention can be used as inner liners of gun barrels and similar tubes for repeatedly guiding fired projectiles.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing a side-view of an exemplary forward flowforming device.

FIG. 2 is a schematic diagram showing a side-view of an exemplary reverse flowforming device.

### DETAILED DESCRIPTION OF THE INVENTION

A description of preferred embodiments of the invention follows. While this invention has been particularly shown and described with references to preferred embodiments thereof, it will be understood by those skilled in the art that various changes in form and details may be made therein without departing from the scope of the invention encompassed by the appended claims.

This invention pertains to tubes for repeatedly guiding fired projectiles and to flowforming methods of fabricating these tubes. These tubes include rifle barrels, machine gun barrels, shotgun barrels, howitzer barrels, cannon barrels, naval gun barrels, mortar tubes, rocket launcher tubes, grenade launcher tubes, pistol barrels, revolver barrels, chokes for any of the previously stated barrels or tubes, and tubes for similar weapon systems. These tubes are integral to weapons designed to propel projectiles toward a target designated by the user of the weapon. These tubes are enclosed hollow cylinders whose length is in excess of their diameter. These tubes may have a smooth inner surface or contain helical rifling to impart spin to the fired projectile. The projectiles include bullets, shot, spheres, rockets, rounds, shells, grenades, and similar projectiles. In the firing process of these projectiles, the projectile is initially located near one end, e.g., the breech end, of the tubular device. A propellant located behind the projectile is ignited or initiated and the explosive expansion of the gases created by the burning or other chemical reactions occurring in the propellant causes the projectile to rapidly accelerate as it proceeds down the remaining length of the tube until it exits the distal or muzzle end of the tube. If propellant is still attached to the rear end of the projectile, burning or another reactive chemical process can cause further acceleration of the projectile after the projectile has exited the tube. The tube acts as a guiding or aiming device for the projectile, as well as an enclosed space so the ignited or initiated propellant can push or accelerate the projectile down the tube during the burning or chemical reaction process.

The metals that form the tubes of this invention include nickel-based superalloys, cobalt-based superalloys, iron-based superalloys, high strength steel, titanium, and titanium alloys. These metals have the property of being strong (able to maintain their shape when subject to shock) often at elevated temperatures. These metals also do not corrode easily, either due to oxidation or to the corrosive environments created by the propellants as they force the projectiles through the barrels or tubular devices. These metals are not eroded to an appreciable extent by the projectiles or the propellant gases during the firing process, even with multiple firings. These metals can withstand heat generated by repetitive firing of projectiles without noticeable loss of strength. They are also resistant to increased corrosion that can occur at the elevated temperatures caused by such firing. These properties allow the barrels and tubular devices to be made with thinner walls than previously feasible. These properties of these metals also allow inner liners for barrels and similar tubular devices to now be made. The liners can then be surrounded by other metals, or with composite filament wraps, or resins for structural or cosmetic purposes.

Further metals that form the tubes of this invention include tantalum and tantalum alloys, chromium and chromium alloys, zirconium and zirconium alloys, as well as niobium and niobium alloys. Although these metals do not have the strength property of the previously listed metals, they possess the desired properties of withstanding elevated temperatures, and corrosion and erosion resistance at normal as well as elevated operating temperatures, without losing their projectile aiming property. These metals are particularly suited for fabrication into inner liners of barrels and tubular devices. These inner liners can then be surrounded by other metals, composite filament wraps, or resins to provide structural strength to the barrels or tubular devices.

There are numerous specific metals that can be used in the methods and articles of manufacture of this invention. Superalloys, in particular, can be used. Superalloys are high performance materials designed to provide high mechanical strength and resistance to surface degradation at high temperatures of 1200° F. (650° C.) and above. These alloys combine high tensile, creep-rupture, and fatigue strength; good ductility, and toughness, with excellent resistance to oxidation and hot corrosion. The superalloys are designed to retain these properties during long-term exposures at elevated temperatures (e.g., see Frank, Selection of Age-Hardenable Superalloys, June 2005, CRS Holdings Inc., Reading Pa., USA, incorporated herein by reference). Superalloys with the same composition are often made by different mills, who attach their specific tradename to their product. For example, Alloy 718 is referred to as Inconel 718, Pyromet 718, or Nickelvac 718, depending on the mill that produces this alloy. Because different mills produce superalloys, these metals are sometimes organized by the industry into families depending on their tradenames (i.e., their manufacturer). The families include the Inconel, Hastelloy, Stellite, Nickelvac, and Pyromet superalloys. Examples of specific superalloys that can be used in the present invention are Alloy X-750B, Alloy X-750A, Alloy 80A, Alloy A-286, Alloy 31V, Alloy 625, Alloy 706, Alloy 725, Alloy 751, Alloy 901, Alloy 706, Alloy 41, Alloy 718, Alloy 720, Alloy CTX-909, Alloy NCF 3015, Alloy Thermospan, Alloy Waspaloy, Alloy Waspaloy A, Alloy Waspaloy B, Alloy Haynes 228, Alloy B3, Alloy C-276, Alloy 601, Alloy Rene 220, and Alloy PWA 1472.

High strength steels can also be used in the methods and articles of manufacture of this invention. High mechanical strength and retention of this strength at elevated temperatures are properties that are sought for these steels in this invention. Specific examples of such steels are Maraging Steel C-250, Maraging Steel C-300, and Maraging Steel T-250.

Another group of metals that can be used in the methods and articles of manufacture of this invention are titanium and titanium alloys. These titanium metals occur in alpha (α), alpha-beta (α-β), or beta (β) crystallographic forms. These metals are highly corrosion resistant, lightweight and also possess the desired properties of tensile strength, toughness, and resistance to fatigue, even at the high temperatures that are created when rapid repetitive firing of projectiles occurs. Examples of these metals are Titanium 6Al-4V, Titanium 6Al-4V ELI, Titanium 3Al-2.5V, Titanium 6Al-2Sn-4Zr-2Mo, Titanium 6Al-2Sn-4Zr-6Mo, and Titanium 4Al-2.5V.

Further metals that can be used in the methods and articles of manufacture of this invention are tantalum, tantalum alloys, chromium, chromium, chromium alloys, zirconium, zirconium alloys, niobium, and niobium alloys. These metals are less strong than the previously discussed metals but have the beneficial property of corrosion resistance, even at the high temperatures generated by rapid repetitive firing of projectiles. Examples of these metals are Tantalum, Tantalum 2.5 W, and Tantalum 5 W. This latter group of metals is particularly well-suited for use as inner liners of gun barrels and other tubular devices for repeatedly guiding fired projectiles.

The inner liners that are embodiments of this invention can be supported by an outer structure that provides sufficient tensile and fatigue strength to maintain the liners in their proper configuration for repeatedly guiding fired projectiles. The supporting structures can be metals, such as the superalloys, high strength steels, or titanium or its alloys as previously discussed, or other metals such as the steels, including “Damascus” steels (http://www.damasteel.biz) and carbon steels, used in presently conventional gun barrels or tubular devices for repeatedly guiding fired projectiles. Alternatively, the inner liners can be structurally supported by high strength composite filament wraps or resins. These polymeric materials have tensile toughness and can be added to the outside of the liners following their flowformed fabrication to provide the necessary rigidity to these liners. These metal and polymeric supporting structures are most often used when tantalum, tantalum alloys, chromium, chromium alloys, zirconium, zirconium alloys, niobium, or niobium alloys are employed as inner liners of gun barrels or similar tubular devices for repeatedly guiding fired projectiles. When the supporting structures are metals, such as superalloys or titanium alloys or a steel that is used in presently conventional gun barrels or similar tubular devices, these supporting structures can be flowformed into their final cylindrical shape. In these instances, both the supporting structure and inner liner are flowformed. They are subsequently assembled to produce the sought gun barrel or tubular device for repeatedly guiding fired projectiles.

The present invention also includes tubes for repeatedly guiding fired projectiles and flowforming methods of fabricating such tubes where the starting preform is made of two or more metals that have been integrally bonded together before the flowforming step is performed. The two or more metals are integrally bonded together by any suitable process, such as hot isostatic pressing (HIPing), diffusion bonding, and shrink fitting. One of these metals is a metal described in the foregoing embodiments of the invention; i.e., a nickel-based superalloy, a cobalt-based superalloy, an iron-based superalloy, a high strength steel, titanium, a titanium alloy, tantalum, a tantalum alloy, chromium, a chromium alloy, zirconium, a zirconium alloy, niobium, or a niobium alloy. At least one metal of these preforms (the other metal if only two metals are used) is not a metal from this group of metals. For example, the second metal can be a steel that is not an iron-based superalloy or a high strength steel. A steel that is used in presently conventional gun barrels or similar tubular devices can be the second metal.

### Metal Preform

To produce the tubes for repeatedly guiding fired projectiles of this invention, a metal preform is fabricated to be the starting material for the subsequent flowforming operations. The metal preform is the workpiece from which the gun barrels or similar tubular devices are flowformed. Typically, the metal preform is fabricated into the workpiece shape of a hollow cylinder which as one or two open ends.

The fabrication of the metal preform is achieved by one or more processes known in the material processing art. These processes include extrusion, casting, rolling, gun drilling, machining, hot isostatic pressing (also known as “HIPing”), rotary-piercing, rotary forging, and combinations thereof.

In some instances, the fabrication of the metal preform includes extrusion of at least a portion of the metal or metals that comprise the preform. In further refinements of these instances, the fabrication of the metal preform includes extrusion of at least a portion of the metal or metals that comprise the preform where the metal or metals are in the form of a bar, a billet, a consolidated metal powder (e.g., a metal powder that has been sintered and HIPed), and/or a metal casting. In other instances, the fabrication of the metal preform includes machining a cast billet, a cast bar, a cast hollow, a rolled bar, or a rolled billet of the metal or metals.

### Flowforming Gun Barrels and Similar Tubular Devices

Flowforming is an advanced cold-forming process for the manufacture of hollow components. Flowforming allows for the production of dimensionally precise and rotationally symmetrical components and is typically performed by compressing the outside diameter of a cylindrical component or preform over an inner rotating mandrel using a combination of axial and radial forces from one or more rollers. The metal is compressed and plasticized above its yield strength and made to flow in the axial direction onto a mandrel. The workpiece being formed, the rollers, and/or the mandrel can rotate. Two examples of flowforming methods are forward flowforming and reverse flowforming. Generally, forward flowforming is useful for forming tubes or components having at least one closed or semi-closed end (e.g., a closed cylinder). Reverse flowforming is generally useful for forming tubes or components that have two open ends (e.g., a tube having two open ends).

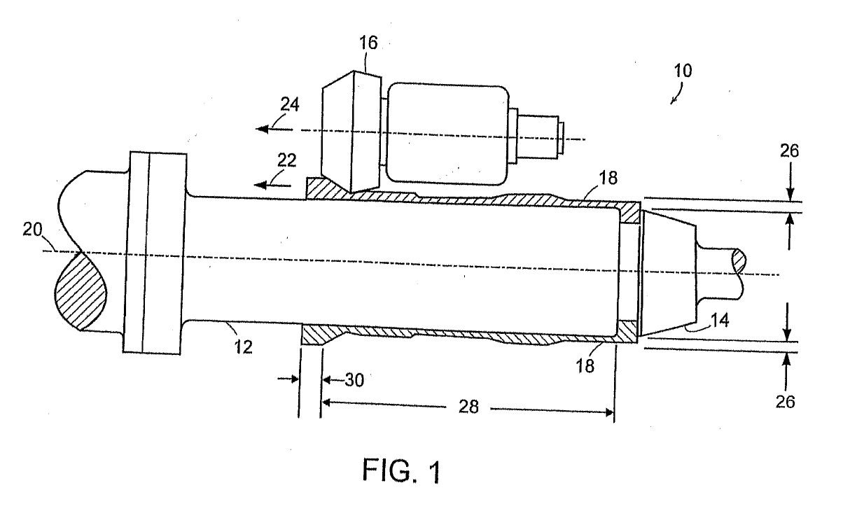

FIG. 1 illustrates a schematic diagram showing a side-view of exemplary forward flowforming device 10. Device 10 includes mandrel 12, tailstock 14, and roller 16. Preform 18 is a metal, a metal alloy, or a two or more bonded metals tube or hollow cylinder having one open end.

In operation, preform 18 is placed over mandrel 12. Mandrel 12 rotates about major axis 20. Tailstock 14 applies an amount of force or pressure to preform 18 to cause the preform to rotate with mandrel 18. As mandrel 12 and preform 18 rotate, roller 16 is moved into a position so that it contacts the outer surface of preform 18 at a desired point along the length of the preform. Roller 16 compresses the outer surface of preform 18 with enough force so that the metal of the preform is plasticized and caused to flow in direction 22, generally parallel to axis 20. Roller 16 can be positioned at any desired distance from the outer diameter of mandrel 12 or the inner wall of preform 18, thereby compressing the walls of the preform to any desired thickness at the point of compression. For example, the walls of preform 18 can be compressed to width 26 at a point of compression.

While mandrel 12 and preform 18 continue to rotate, roller 16 is moved down the length of preform 18, generally in direction 24, thereby compressing additional portions of the length of preform 18 to a desired thickness. As it moves down the length of preform 18, roller 16 can be positioned at different distances relative to mandrel 12 or it can be kept at the same distance relative to mandrel 12. As the roller(s) move(s) down the length of a preform, the roller(s) deform(s) the preform into a metal or metal alloy tube having walls with a desired thickness or thicknesses. In FIG. 1, length 28 represents the portion of the preform that has been formed into the metal tube. Length 30 represents additional portions of the preform that have yet to be formed. This operation is termed “forward flowforming” because the deformed material flows in the same direction that the rollers are moving.

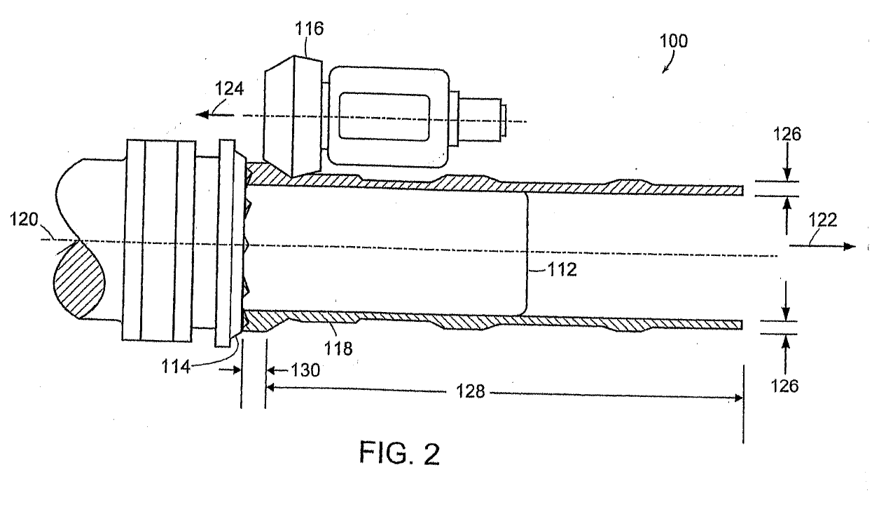

FIG. 2 illustrates a schematic diagram showing a side-view of exemplary reverse flowforming device 100. Device 100 includes mandrel 112, drive ring 114, and roller 116. In some embodiments, the flowforming device includes more than one roller (e.g., two or three rollers), usually angularly equidistant from each other relative to the center axis of the workpiece. Preform 118 is a metal, a metal alloy, or a two or more bonded metals tube or hollow cylinder having two open ends.

In operation, preform 118 is placed over mandrel 112 and pushed against drive ring 114. Mandrel 112 rotates about major axis 120. As mandrel 112 rotates, roller 116 is moved into a position so that it contacts the outer surface of preform 118 at a desired point along the length of the preform. Roller 116 presses preform 118 against drive ring 114, thereby causing preform 118 to rotate with mandrel 112. Drive ring 114 has a series of protruding splines on its face or other means for securing preform 118 so that it will rotate with mandrel 112. Roller 116 compresses the outer surface of preform 118 with enough force so that the metal of the preform is plasticized and caused to flow under roller 116 and in direction 122, generally parallel to axis 120. Roller 116 can be positioned at any desired distance from the outer diameter of mandrel 112 or the inner wall of preform 118, thereby compressing the walls of the preform to any desired thickness at the point of compression. For example, the walls of preform 118 can be compressed to width 126 at a point of compression.

While mandrel 112 and preform 118 continue to rotate, roller 116 is moved down the length of preform 118, generally in direction 124, thereby compressing additional portions of the length of preform 118 to a desired thickness or thicknesses. As it moves down the length of preform 118, roller 116 can be positioned at different distances relative to mandrel 112 or it can be kept at the same distance relative to mandrel 112. As the roller(s) move(s) down the length of a preform, the roller(s) deform(s) the preform into a metal or metal alloy tube having walls with any desired thickness. In FIG. 2, length 128 represents the portion of the preform that has been formed into the metal tube. Length 130 represents additional portions of the preform that have yet to be formed. As the tube is formed, it is extended down the length of the mandrel away from drive ring 114. This operation is termed “reverse flowforming” because the deformed material flows in the direction opposite to the direction that the rollers are moving.

A preform may be subjected to one or more (e.g., at least two, three, four, five, or more than five) flowforming passes, with each flowforming pass compressing the walls of the preform or some portion of the walls of the preform into a desired shape or desired thickness.

### Advantages of Flowforming Gun Barrels and Similar Tubular Devices

Flowforming offers a myriad of advantages relative to more conventional machining and forming processes such as forging, extruding, and casting. These advantages include:
Net shape forming, which saves expensive material and eliminates the need to machine solid bar or heavy wall forging/extrusion, thereby allowing gun barrels and similar tubular devices to now be economically available from superalloys and other materials;
Seamless construction, which eliminates welds;
Accurate dimensional control, thereby eliminating the need for secondary finish machining operations, including grinding and honing;
Capability to form thin walls regardless of the tube diameter size;
Ability to form tapered walls and/or components;
Refined, uniform, directional grain structure;
Improved tensile, hoop strength and hardness;
Very fine inner diameter (ID) and outer diameter (OD) surface finishes;
Ability to form pre-hardened metals, thereby eliminating the need to deal with distortion from post-form heat treatment;
Integral ID or OD flanges, eliminating circumferential welds;
Repeatable accuracy that is computer-controlled;
Economical tooling with one flowforming machine and one mandrel.
   Specific to the manufacture of gun barrels, flowforming offers the following metallurgical, mechanical, dimensional, and economic advantages.

### Metallurgical Advantages

Because the flowforming operation uses uniform, rolling, radial compressive forces to plasticize the preform material (versus axial shear forces used on a forge or extrusion press), very high strength materials can be plasticized and flowformed. For example, C-350 Maraging Steel (388 KSI Ultimate Tensile Strength), 718 Inconel, Waspaloy, Titanium 6Al-4V, Titanium and MP35N (Multi-Phase 35% Cobalt, with Nickel), all of which are extremely difficult to forge or extrude at 2000 degrees Fahrenheit, can be routinely flowformed with precision during the flowforming process.

A by-product of the benign compressive forces employed to plasticize the preform material are the large wall reductions achieved with the flowforming process. Typical wall reductions range from 70%-85% without the need for intermediate annealing. As a result of the large wall reductions that occur during the uniform plastic deformation process, the grain structure of the metal material of the walls becomes refined. The refinement of the grain structure helps eliminate potential stress corrosion cracking in the field and keeps the component stable during post-forming heat treatment, particularly if a quenching operation is required. Additionally, the large wall reductions insure that there is no porosity, and no inclusions, clumps of non-metallic stringers (such as sulfur or phosphorus), or large concentrations of delta ferrite in the flowformed component. Impurities present in the preform material are completely broken up and homogenized during the plastic deformation and large wall reductions, thereby making the flowform product 100% dense and metallurgically uniform. Finally, the fine grain structure that results from flowforming allows for more consistent and uniform dimensional control of gun barrels and similar tubular devices during usage, especially when the barrels and tubular devices get very hot from repetitive firing.

### Mechanical Advantages

Unlike forging, extruding or casting, the flowforming process is performed at room temperature. While heat is generated at the point of deformation (a result of contact between the rollers and the work piece), and the adiabatic heat generated is substantial, the flowforming process occurs below the recrystallization temperature of the metal material and is therefore considered a “cold forming process.” A distinct set of results from this cold work are improved mechanical properties.

For example, it is typical to boost the ultimate tensile strength of stainless steel or 4000 series steel 25%-50% by the cold work induced in the material through the flowforming process. Moreover, while the strength of steel is increased by the cold work, ductility—which traditionally suffers when strength is increased—is often maintained at high levels, with even greater than 10% elongation of the material. These phenomena can be attributed to the combination of the cold work and the refinement of the grain structure, which eliminates the large grain boundaries found in the preform material, thereby making the flowformed product stronger and ductile.

### Dimensional Advantages

Through the flowforming process, the preform material is plasticized and formed over a rotating mandrel, inherently resulting in a very precise and round inner diameter. Moreover, the balance, speed, carefully chosen roller angles, and uniform compression of the rollers result in an extremely round part (within 0.003″) with exacting concentric wall thickness (within 0.001″), while also achieving an uncommon straightness (0.001″ per foot). There is not a forge, extrusion, or cast process that can come close to achieving the roundness and concentricity of the flowformed process. The flowformed inner diameters are at times held to +/−0.001″, often eliminating the need for post-flowforming honing.

As well, the ability to cold form high strength materials such as superalloys through the flowforming process is instrumental to achieving tighter dimensional controls than possible through conventional machining processes. Forging, extruding, and casting are performed under hot conditions where dimensional control suffers; this lack of dimensional control requires that, to achieve the required dimensions, extra material be intentionally added to the work piece for subsequent removal, e.g., by a machining operation, after the forming operation. It is extremely difficult—often impossible—for these secondary machining processes (required as part of the hot forming processes) to achieve the same tolerances as those achieved by a one-time flowforming process. Moreover, the additional material, time and skill required by the conventional (hot) processes significantly increase the costs of making gun barrels and similar tubular devices. For these reasons, hot forming of the gun barrels and similar tubular devices is not cost effective. However, the cold forming process of flowforming gun barrels and similar tubular devices is a practical and economical procedure.

In short, the flowforming process matches or exceeds the machining accuracies achieved by conventional gun barrel processes, at far less cost. Table 1 below outlines the typical tolerances achieved through the flowforming process.

TABLE 1
Typical Flowforming Tolerances
SIZE RANGE OF FINISHED COMPONENT

| | | | | | |
|---|---|---|---|---|---|
| INSIDE | inch | 0.466-3.94 | 3.94-9.84 | 9.84-15.75 | 15.75-24.50 |
| DIAMETER | mm | 12-100 | 100-250 | 250-400 | 400-622 |
| WALL | inch | 0.006-0.400 | 0.010-0.500 | 0.015-0.500 | 0.020-0.600 |
| THICKNESS | mm | 0.15-10.16 | 0.25-12.7 | 0.40-12.7 | 0.50-15.25 |

TOLERANCES

| | | | | | |
|---|---|---|---|---|---|
| Inside Diameter | inch | +/−0.001 | +/−0.003 | +/−0.004 | +/−0.005 |
| | mm | +/−0.025 | +/−0.075 | +/−0.10 | +/−0.125 |
| Wall Thickness | inch | +/−0.001 | +/−0.0015 | +/−0.002 | +/−0.003 |
| | mm | +/−0.025 | +/−0.04 | +/−0.05 | +/−0.075 |
| Ovalness (max.) | inch | 0.003 | 0.005 | 0.008 | 0.010 |
| | mm | 0.075 | 0.125 | 0.20 | 0.25 |
| Concentricity | inch | 0.001 | 0.002 | 0.0025 | 0.003 |
| (max.) | mm | 0.025 | 0.050 | 0.065 | 0.075 |
| Straightness (max.) | inch | 0.001/ft | 0.0015/ft | 0.002/ft | 0.003/ft |
| | mm | 0.08/1000 | 0.125/1000 | 0.17/1000 | 0.25/1000 |
| Internal Surface | inch | 8 | 8 | 8 | 8 |
| Finish | mm | 0.2 | 0.2 | 0.2 | 0.2 |
| External Surface | inch | 16 | 24 | 32 | 32 |
| Finish | mm | 0.4 | 0.6 | 0.8 | 0.8 |

On a consistent basis, the flowforming process is capable of more cost-effectively producing high precision components, particularly with expensive materials, than when conventional fabrications are performed. This is particularly true when the desired final components have large length to diameter ratios and/or have thin wall thicknesses relative to their diameters, as is the case with the production of gun barrels and similar tubular devices.

The average flowform preform is typically four times shorter than the finally fabricated component. This allows the short preform to be easily and economically produced by machining from solid bar stock and to be subsequently flowformed to its final net-shape. To conventionally produce the same final product, e.g., by machining, would require an initial solid bar four times the length of the preform (and four times more expensive), while also involving substantial additional material loss as well as much time machining the entire bore of the component.

Additionally, because the preform is elongated to its final net shape over a mandrel, and therefore to the final net shape of the finished component, there is often no need for timely and expensive secondary machining operations. This is of particular advantage when the material is hardened and, therefore, difficult to machine. In short, flowforming offers a chipless forming process, capable of forming high strength materials, such as superalloys, to net size, even when tight dimensional control is required. For these reasons, flowforming has excellent economical advantages to forging, extruding, casting, or machining from a solid bar/billet.

### High Temperature Alloys

The advancement of age-hardenable superalloys and other high strength metals combined with the flowforming manufacturing process have now allowed for the design and fabrication of gun barrels and similar tubular devices that can withstand the corrosive environments and extensive heat generated by projectile firing, particularly repetitive projectile firing. These advancements greatly inhibit the in-service wear and corrosion of the bores of the barrels and tubes, while helping to maintain the straightness and roundness of these tubular devices as they are used. The high strength associated with these materials also now allows product developers to reduce the wall thicknesses of the barrels and tubes, thereby creating a lighter component.

Superalloys are high-performance materials designed to provide high mechanical strength and resistance to surface degradation at high temperatures of 1200° F. (650° C.) or above. They combine high tensile, creep-rupture, and fatigue strength, as well as good ductility and toughness, with excellent resistance to oxidation and hot corrosion. Furthermore, superalloys are designed to retain these properties during long-term exposures to the elevated temperatures. The primary application for superalloys has been in hot sections of aircraft gas turbine engines, accounting for over 50% of the weight of advanced engines. In addition to the aerospace industry, these alloys are used in turbine engines for marine, industrial, land-based power generation, and in oil exploration instrument housings, rocket engines, space, petrochemical/energy production, internal combustion engines, metal forming (hot-working tools and dies), heat-treating equipment, nuclear power reactors, and coal conversion. While these alloys are primarily used for service at elevated temperatures above 1000° F. (540° C.), the characteristics of high strength and excellent environmental resistance have made many superalloys an excellent choice for lower-temperature applications. Examples of these applications are prosthetic devices in the medical industry and components for deep sour gas wells in the oil/gas exploration industry. Historically, these materials have not been utilized to their full capacity with conventional machining processes due to the high costs of these advanced materials which contain large percentages of nickel and cobalt. Because flowforming forms to net shape, less of these expensive materials is required, thereby making the high strength superalloys and steels more economical. Together, flowforming and superalloys are the foundation for novel, high strength, high precision, high ductility, high corrosion resistance, economical gun barrels and similar tubular devices.

### Chemical Compositions

Table 2 contains examples of nominal compositions of common wrought age-hardenable superalloys. These alloys contain various combinations of nickel, iron, cobalt, and chromium with lesser amounts of other elements including molybdenum, niobium, titanium, and aluminum. With minor additions of beneficial elements such as boron and zirconium, these alloys may contain up to 12 intentional additions. All these additions help impart and maintain the desired properties of these superalloys at elevated temperatures.

TABLE 2
Nominal Compositions of Wrought Age-Hardenable Superalloys
(Weight Percent)

| Alloy | C | Mn | Si | P | S | Cr | Ni | Co | Mo | Ti | Al | Nb | B | Zr | Fe | Other |
|---|---|---|---|---|---|---|---|---|---|---|---|---|---|---|---|---|
| A-286 | 0.04 | 1 | 0.5 | 0.02 | 0.005 | 14.5 | 25 | — | 1.25 | 2 | 0.2 | — | 0.006 | 0.05 | Bal | 0.3 V |
| | | max | max | max | max | | | | | | | | | max | | |
| NCF | 0.04 | 0.5 | 0.5 | 0.02 | 0.005 | 14.5 | 31 | — | 0.7 | 2.7 | 1.9 | 0.7 | 0.003 | — | Bal | |
| 3015 | | max | max | max | max | | | | | | | | | | | |
| 706 | 0.02 | 0.2 | 0.2 | 0.01 | 0.002 | 16 | 42 | — | — | 1.7 | 0.2 | 3 | 0.002 | — | Bal | |
| | | max | max | max | max | | | | | | | | | | | |
| 901 | 0.03 | 0.2 | 0.2 | 0.02 | 0.005 | 13.5 | 43 | — | 6 | 3 | 0.2 | — | 0.015 | — | Bal | |
| | | max | max | max | max | | | | | | | | | | | |
| 718 | 0.04 | 0.2 | 0.2 | 0.02 | 0.002 | 18.5 | 53 | — | 3 | 1 | 0.5 | 5.3 | 0.004 | — | 19 | |
| | | max | max | max | max | | | | | | | | | | max | |
| 41 | 0.07 | 0.2 | 0.2 | 0.01 | 0.002 | 19 | 54 | 11 | 10 | 3.2 | 1.7 | — | 0.006 | 0.04 | 2 | |
| | | max | max | max | max | | | | | | | | | | max | |
| 720 | 0.02 | 0.2 | 0.2 | 0.01 | 0.002 | 16 | 57 | 15 | 3 | 5 | 2.5 | — | 0.015 | 0.04 | 0.5 | 1.25 W |
| | | max | max | max | max | | | | | | | | | | max | |
| 31V | 0.04 | 0.5 | 0.2 | 0.02 | 0.005 | 23 | 57 | — | 2 | 2.3 | 1.3 | 0.9 | 0.005 | 0.05 | 14 | |
| | | max | max | max | max | | | | | | | | | | | |
| Wasp- | 0.04 | 0.2 | 0.2 | 0.01 | 0.002 | 19 | 58 | 13 | 4.25 | 3 | 1.4 | — | 0.005 | 0.05 | 2 | |
| alloy | | max | max | max | max | | | | | | | | | | max | |
| 751 | 0.05 | 0.5 | 0.5 | 0.02 | 0.005 | 15.5 | 71 | — | — | 2.4 | 1.3 | 1 | 0.004 | 0.05 | 9 | |
| | | max | max | max | max | | | | | | | | | | max | |
| X-750 | 0.05 | 0.5 | 0.5 | 0.02 | 0.005 | 15 | 72 | — | — | 2.6 | 0.75 | 0.9 | 0.004 | 0.05 | 9 | |
| | | max | max | max | max | | | | | | | | | | max | |
| 80A | 0.07 | 0.5 | 0.5 | 0.02 | 0.005 | 20 | 75 | — | — | 2.4 | 1.4 | — | 0.004 | 0.05 | 2 | |
| | | max | max | max | max | | | | | | | | | | max | |
| CTX- | 0.02 | 0.2 | 0.4 | 0.01 | 0.002 | 0.5 | 37 | 14 | — | 1.6 | 0.15 | 5 | 0.01 | — | Bal | |
| 909 | | max | | max | max | max | | | | | max | | max | | | |
| Thermo- | 0.02 | 0.2 | 0.35 | 0.01 | 0.002 | 5.5 | 25 | 29 | — | 0.9 | 0.5 | 5 | 0.005 | — | Bal | |
| Span | | max | | max | max | | | | | | | | | | | |

(Table 2 adapted from information contained in an information and marketing document prepared by R. B. Frank, CRS Holdings, Inc., a subsidiary of Carpenter Technology Corporation)
Thermo-Span is a registered trademark of CRS Holdings, Inc.

Superalloys can be classified into nickel-base, iron-base, and cobalt-based groups. Nickel-based superalloys (>50% Ni) are the most common group. About half of the alloys in Table 2 are considered nickel-base alloys and the others contain large additions of nickel. The nickel base has a high tolerance for alloy additions that might otherwise cause phase instability leading to loss of strength, ductility, and/or environmental resistance. Although there are some cobalt-base superalloys, they are significantly higher in cost and typically cannot be age hardened to high strength levels. However, cobalt is an important alloying addition to nickel-based alloys because it extends the maximum temperature for usage by reducing the solubility of the age-hardening phase. Alloy Waspaloy, Alloy 41, and Alloy 720 are nickel-base alloys with 10-15% cobalt additions. These alloys have the highest temperature capability of the common wrought age-hardenable superalloys. Chromium, usually in the range of 14 to 23 weight percent, is a critical alloying addition to nearly all superalloys. As in stainless steels, chromium forms a tightly-adherent, protective oxide film (Cr₂O₃) on the alloy surface to resist oxidation and corrosion at high temperatures as well as corrosion at lower temperatures. This surface layer protects the alloy from the harmful effects of the elements oxygen, nitrogen, and sulfur.

The major strengthening method in superalloys is age-hardening. Yield strength of nickel alloys is typically increased by a factor of two or three by precipitation of the gamma prime and/or gamma double prime Ni₃(Al, Ti, Nb) hardening phase. The gamma prime phase is rather unique because its strength actually increases with temperature up to 1200° F. (650° C.) and it is relatively ductile and resistant to oxidation. Gamma prime precipitates as very fine spheroidal or cuboidal particles in the nickel-iron matrix during aging. While most of the superalloys employ the titanium-rich gamma prime phase for age hardening, a niobium-rich variant called gamma double prime is the primary strengthening phase in some superalloys such as Alloy 718. The niobium-rich phase provides higher strength up to 1200° F. (650° C.) but is unstable above 1200° F. Thus, Alloy 718 superalloys have a lower temperature limit than the alloys strengthened with the titanium-rich gamma prime phase. Since the gamma double prime reaction is more sluggish, these superalloys also tend to have better workability. Proper heat treatment is critical to achieving the desired set of properties in age-hardenable superalloys. The initial solution heat treatment typically dissolves all precipitated phases except for some primary carbide and nitride phases. The typical range for the wrought age-hardenable superalloys is 1650-2100° F. (900-1150° C.) for one to four hours followed by a rapid air cool or a quench in water, polymer or oil. The aging range for age-hardenable superalloys is 1150-1600° F. (620-870° C.). Aging times range from four hours to 24 hours. Double-aging treatments are quite common to maximize strength and to develop the best combination of short-term tensile and long-term creep-rupture properties of these superalloys. Primary aging treatment precipitates a coarser distribution of the hardener phase and may also improve the type and distribution of carbides on grain boundaries. The secondary age is typically established about 200° F. (90° C.) below the primary aging temperature, precipitating a finer dispersion of the gamma prime phase. For some higher-strength applications, the superalloys are direct aged after hot, warm, or cold working without an intermediate solution treatment. The strain from working is used to further enhance tensile and fatigue properties of the materials with some sacrifice in the creep-rupture properties.

Titanium is a metal that has excellent resistance to corrosion, and has a high strength-to-weight ratio. It also exhibits excellent ductility. It is corrosion resistant and is often used in strong light-weight alloys. Titanium 6Al-4V is a general purpose α-β alloy in widespread use. It contains a favorable balance of properties with moderately high tensile strength, good fatigue strength, with intermediate fracture toughness. Its properties are reasonably retained up to about 660° F. (350° C.). This alloy is hardenable in sections up to 1.0 in (2.54 cm) thick and is weldable by various methods provided the joint area is clean before welding. Titanium 6Al-4V alloy is highly resistant to general corrosion in sea water. This alloy is made in several variants. The ELI (ASTM Grade 23) variant is available for fracture critical applications.

Tantalum is a gray, heavy, very hard metal. When pure, it is ductile and can be drawn into fine wire. Tantalum is almost completely immune to chemical attack at temperatures below 150° C. (330° F.) and is attacked only by harsh acids. It has a very high melting point. Tantalum is used to make a variety of alloys with desirable properties such as high melting point, high strength, good ductility, etc. Tantalum has a good “gettering” ability at high temperatures.

Chromium is a steel-gray, lustrous, hard metal that can be highly polished. It has a high melting point and can be used to coat other metals to provide corrosion resistance. Chromium is easily oxidized to produce a thin oxide layer on its surface. This layer is impermeable to oxygen so it protects the metal below it, thereby protecting this metal from oxidation. Alloys of chromium retain desirable properties of chromium. These alloys have excellent resistance to high temperature oxidation and corrosion and have good wear resistance.

Zirconium is a lustrous, gray-white, strong metal. It is both heat and corrosion resistant. It is lighter than steel and is often used in alloys. It has good ductility as well as “gettering” ability.

Niobium is a shiny gray, ductile metal whose chemical characteristics are similar to those of tantalum. It is often alloyed with other metals to increase the strength and heat resistance of the resultant material.

### Further Characteristics and Embodiments

As previously stated, the flowforming process allows the tubes for repeatedly guiding fired projectiles to have tubular wall thicknesses that vary along the length of the tube. These flowformed gun barrels and similar tubular devices can have wall thicknesses that vary in stepwise fashion one or more times along the length of the barrel or tube, or vary in a smooth fashion, linearly or nonlinearly, from thicker to thinner, or vice versa, one or more times along the length of the barrel or tube. Stepwise and gradual wall thickness gradations can be achieved as many times and in any order as desired along the length of the barrel or tube when the flowforming process is utilized.

Additionally, the inner diameter of the gun barrel or similar tubular device can be altered along the length of the barrel or tubular device by proper construction of the mandrel. As flowforming is performed, the inner surface of the metal is forced to conform to the dimensions of the mandrel. If the diameter of the mandrel changes along its length, the inner diameter of the barrel or tubular device likewise changes. An example of such a flowforming construction is when the muzzle end of the tubular device is fabricated into a horn-like shape. Such a shape may be desired to more controllably dissipate the projectile propellant gasses as the projectile leaves the tubular device; e.g., a mortar tube. These horn-like shapes are often known as blast attenuation devices (BAD) in the weapons industry. The horn-like muzzle shape in this invention is achieved by increasing the diameter of the mandrel, usually by increasing its diameter in a continuous manner, as flowforming of the workpiece is concluded. For example, this increase in mandrel diameter, and resultant increase in the inner diameter of the tubular device, can begin approximately 12 inches (30.48 cm), or less from the muzzle end of the tube and proceed to the end of the flowformed tube. If desired, the flowforming process can also be adjusted so the wall thickness of the resultant tubular device becomes thinner as its inner diameter is increased.

The mandrel can also be constructed so it imparts rifling, grooves, notches, or other imperfections to the inner surfaces of gun barrels or similar tubular devices as they are flowformed. This is accomplished by constructing the mandrel with spiral, straight, periodic, or other desired ridges on its surface. These ridges leave the rifling, grooves, notches and/or other imperfections in the inner surface of the gun barrel or similar tubular device after the flowforming operation is completed. Alternatively, rifling and/or other indentations can be accomplished by, for example, appropriate machining of the inner surface of the flowformed barrel or tubular device after the flowforming operation is completed.

The dimensions of the flowformed tubes for repeatedly guiding fired projectiles of this invention can be set within a wide range of tolerances including those found for conventional rifles, shotguns, naval guns, handguns, mortars, howitzers, rocket launchers, and grenade launchers. Typically, the length of these tubes is 36 feet (10.98 m) or less, the inner diameter of these tubes is 8 inches (20.32 cm) or less, and the wall thickness of these tubes is between about 0.015 inches (0.038 cm) and 0.600 inches (1.52 cm). Variations beyond these tolerances are also possible with the methods of this invention, particularly for the tubular liners of this invention.

This invention also includes tubes for repeatedly guiding fired projectiles where one end of the tube is closed. These tubes are usually fabricated as one piece from the same metal, as disclosed in this invention, throughout their length and closed end. They are made from a single metal preform. This preform is often forward flowformed when integral tube with closed end is desired. This manufacturing technique is far more economical from the standpoints of cost of material, waste of material, and manufacturing time than techniques traditionally employed. In traditional techniques, the tube and the closed end are separately made and subsequently joined together, e.g., via threading. An example of such a tubular device of this invention for repeatedly guiding fired projectiles where one end of the tubular device is closed is a mortar tube. In these systems, a mortar round is dropped into the tube from the muzzle end of the tube. The mortar round is dropped to the bottom, or butt end, of the mortar tube where a firing pin is permanently located. The firing pin penetrates a propellant chamber located on the back of the projectile, thereby igniting the propellant. The resultant rapidly expanding propellant gases then accelerates the mortar round out of the mortar tube and toward the target. In these instances, the butt end of the mortar tube is entirely closed, thereby entrapping the rapidly expanding propellant gases and maximizing the thus generated force to expel the mortar round. With the methods of this invention, variations in the design of the closed end of such mortar tubes can more easily be achieved (e.g., for the concomitant fabrication of a stand for holding the mortar tube in place during its firing operation). Currently available mortar tubes often have a set of fins associated with the butt end of the tube for dissipating heat that is generated when the mortar rounds are fired. With the present invention, such cooling fin arrangements are not necessary because these tubes with closed ends are made of materials with much less bulk and with more heat resilience than the materials presently used in conventional tubes.

### Annealing

In some embodiments of this invention, one or more optional annealing steps are performed. For example, the metal preform can be annealed before the flowforming step and/or the gun barrel or similar tubular device can be annealed after it is flowformed.

Optionally, one or more annealing steps can be performed between flowforming steps. For example, a metal preform can be subjected to one or more flowforming steps to create a partially flowformed gun barrel or similar tubular device and the partially flowformed barrel or tube is then annealed. The annealed partially flowformed barrel or tube can then be flowformed into an essentially completed gun barrel or similar tubular device. In some embodiments, the entire flowforming process is interspersed with a plurality of annealing steps or passes.

### Machining

In some embodiments of this invention, one or more optional machining steps are performed. For example, the metal preform can be machined before the flowforming step. Such optional machining steps are useful for ensuring the metal preform will have dimensions sufficient to properly fit onto a mandrel of a flowforming machine (e.g., a predetermined inner and/or outer diameter over some portion of the length of the preform). A preform that does not properly fit onto the mandrel may result in an improperly formed gun barrel or similar tubular device and/or damage to the flowforming tooling and/or machine. Often, the preform is machined in order to produce a preform with concentric inner and outer diameters which results in a concentrically even gun barrel or similar tubular device. Machining the preform can also be useful for ensuring the barrel or tube has desirable dimensions or has a desirable volume.

In another embodiment, the formed gun barrel or similar tubular device is optionally machined following the flowforming process. Further, the preform that is being flowformed can be machined between flowforming steps or passes.

1-56. (canceled)

57. A method of making a machine gun barrel, the method comprising:
producing a metal preform selected from the group consisting of a nickel-based superalloy, a cobalt-based superalloy, an iron-based superalloy, a high strength steel, titanium, a titanium alloy, tantalum, a tantalum alloy, chromium, a chromium alloy, and two or more of these metals that have been integrally bonded together; and
flowforming the metal preform to form a machine gun barrel.

58. The method as defined by claim 57 wherein flowforming is performed below the recrystallization temperature of the metal preform material.

59. (canceled)

60. (canceled)

61. The method according to claim 57, wherein flowforming further comprises imparting a helical rifling to an inner surface of the metal preform during flowforming.

62. The method according to claim 57, further comprising:
imparting a helical rifling to an inner surface of the machine gun barrel after flowforming.

63. (canceled)

64. The method of claim 57, wherein flowforming is performed in two or more flowforming passes.

65. A method of making a machine gun barrel, the method comprising:
producing a metal preform by rotary forging, the metal preform selected from the group consisting of a nickel-based superalloy, a cobalt-based superalloy, an iron-based superalloy, a high strength steel, titanium, a titanium alloy, tantalum, a tantalum alloy, chromium, a chromium alloy, and two or more of these metals that have been integrally bonded together;
contacting the metal preform with at least two rollers at a desired point along a length of the metal preform; and
flowforming the metal preform to form a machine gun barrel.

66. The method of claim 65, wherein flowforming is performed in two or more flowforming passes.

67. The method according to claim 65, wherein flowforming is performed below the recrystallization temperature of the metal preform material.

68. The method according to claim 65, wherein flowforming further comprises imparting a helical rifling to an inner surface of the metal preform during flowforming.

69. The method according to claim 65, further comprising:
imparting a helical rifling to an inner surface of the machine gun barrel after flowforming.
